(19) United States
(12) Patent Application Publication
(10) Pub. No.: US 2015/0360908 A1
(43) Pub. Date: Dec. 17, 2015

(54) COLUMN MEMBER FOR AN ELEVATING DEVICE

(71) Applicant: TAIWAN MOVESTAR CO., LTD., Kaohsiung City (TW)

(72) Inventor: Min-Chin CHEN, Kaohsiung City (TW)

(73) Assignee: TAIWAN MOVESTAR CO., LTD., Kaohsiung City (TW)

(21) Appl. No.: 14/584,860

(22) Filed: Dec. 29, 2014

(30) Foreign Application Priority Data
Jun. 17, 2014 (TW) 103120865

(51) Int. Cl. B66B 7/02; B66F 3/08

(52) U.S. Cl. CPC B66B 7/022; B66F 3/08

(57) ABSTRACT

The column member for an elevating device has a body, a channel, an opening and an internal thread. The channel is formed through the body. The opening is formed in a front surface of the body and is in communication with the channel. The width of the opening is shorter than the diameter of the channel. The internal thread is formed on an inner surface of the channel. A rotating member is located in the channel and meshes the internal thread of the channel. The diameter of the rotating member is longer than the width of the opening to prevent the rotating member from coming off the column member via the opening. The column member easily holds the rotating member without any sliding elements, and the combination of the column member and the rotating member is safe.

This application claims the benefit of the Taiwan patent application No. 103120865, filed on Jun. 17, 2014, the entire contents of which are incorporated herein by reference.

### BACKGROUND OF THE INVENTION

1. Field of the Invention

The present invention relates to a column member for an elevating device, and more particularly to a column member provided for mounting a driving device to move the elevating device.

2. Description of Related Art

A conventional elevating device such as an elevator or parking equipment is pulled by a driving assembly to move upward and downward. The driving assembly has a driver and a cable. The cable is connected to the elevating device and the driver. The cable is prone to breaking and is not safe in use.

Therefore, the applicant invents an elevating device having a column member. The column member has a body, a channel and an opening The body has a front surface, a top surface, and a bottom surface. The channel is formed through the body and extends from the bottom surface of the body to the top surface of the body. The channel has an inner surface. The opening is formed in the front surface of the body and is in communication with the channel. The width of the opening is equal to the diameter of the channel. An internal thread is formed on the inner surface of the channel. A driving device is connected to the column member. The driving device has a shell and a rotating member. The shell is connected to the column member. The rotating member is mounted in the shell and engages with the internal thread of the column member.

In operation, the rotating member generates a horizontal component of force, and the width of the opening is equal to the diameter of the channel, so the shell may easily come off the column member. Therefore, multiple sliding elements are further mounted on the shell and hold the body of the column member to prevent the shell from coming off the body. The column member cannot hold the shell without the sliding elements.

To overcome the shortcomings, the present invention tends to provide a column member for an elevating device to mitigate or obviate the aforementioned problems.

### SUMMARY OF THE INVENTION

The main objective of the invention is to provide a column member for an elevating device that can easily hold a rotating member of a driving device.

The column member for an elevating device has a body, a channel, an opening and an internal thread. The body has a front surface, a rear surface, a top surface, a bottom surface, and two side surfaces. The rear surface is opposite to the front surface. The bottom surface is opposite to the top surface. The channel is formed through the body and is connected to the top surface and the bottom surface of the body, and has an inner surface. The opening is formed in the front surface of the body and is in communication with the channel. The width of the opening is shorter than the diameter of the channel. The internal thread is formed on the inner surface of the channel.

A driving device is mounted on the column member, and a rotating member of the driving device is located in the channel and engages with the internal thread of the channel. The rotating member is rotated for moving upward and downward along the channel. Thus, the driving device moves upward and downward along the column member. The rotating member meshes with the internal thread of the channel and the diameter of the channel is longer than the width of the opening. The diameter of the rotating member is longer than the width of the opening. Therefore, the rotating member cannot come off the channel via the opening, and the rotating member is located in the channel firmly to prevent the driving device from coming off the column member and reduce the horizontal component of force generated by the rotating member. The column member easily holds the rotating member without any sliding elements, and the combination of the column member and the rotating member is safe.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a column member for an elevating device in accordance with the present invention;

FIG. 2 is a front view of the column member in FIG. 1;

FIG. 3 is an enlarged cross sectional top view of the column member along line 3-3 in FIG. 2;

FIG. 4 is a perspective view of the column member in FIG. 1 combined with an external structure;

FIG. 5 is an enlarged operational exploded perspective view of the column member in FIG. 4;

FIG. 6 is an enlarged operational perspective view of the column member in FIG. 4; and

FIG. 7 is an enlarged perspective view of the column member in FIG. 4 combined with a driving device; and

FIG. 8 is a top view in partial section of the column member in FIG. 1 combined with a rotating member.

### DETAILED DESCRIPTION OF PREFERRED EMBODIMENT

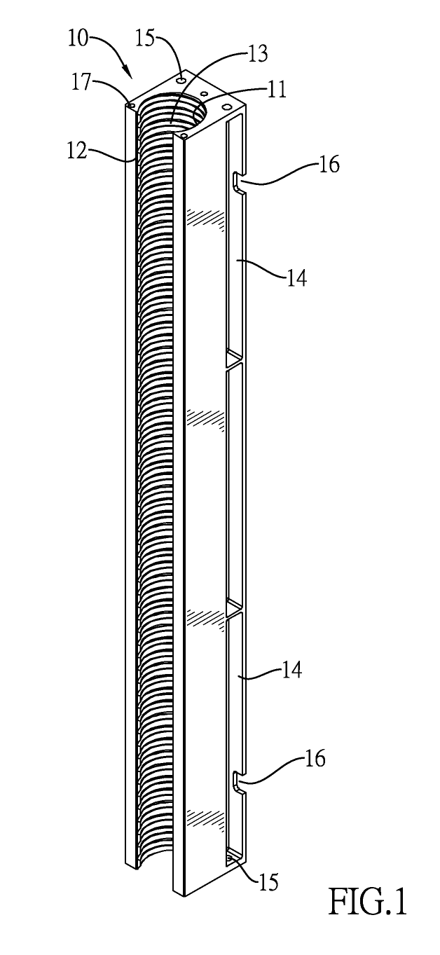

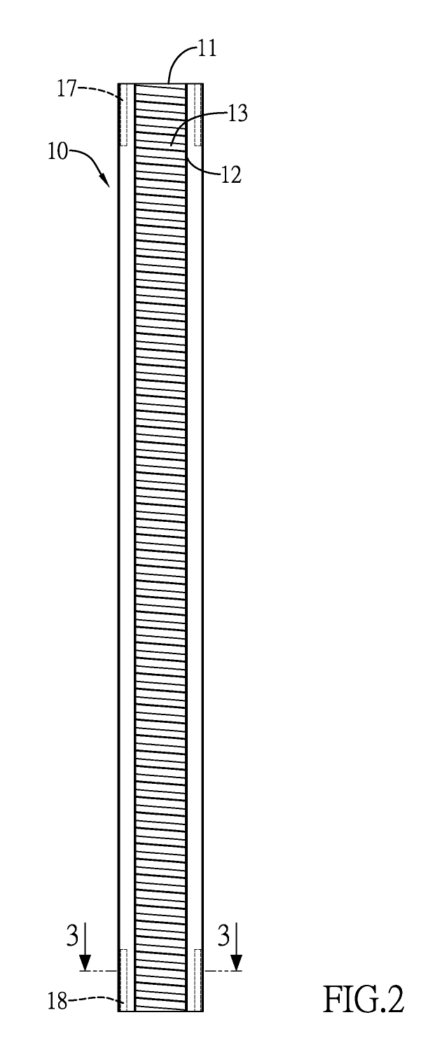

With reference to FIGS. 1 to 3, a column member for an elevating device in accordance with the present invention comprises a body 10, a channel 11, an opening 12 and an internal thread 13. The body 10 has a front surface, a rear surface, a top surface, a bottom surface and two side surfaces. The rear surface is opposite to the front surface. The bottom surface is opposite to the top surface. The channel 11 is formed through the body 10 and is connected to the top surface and the bottom surface of the body 10, and has an inner surface. The opening 12 is formed in the front surface of the body 10 and is in communication with the channel 11. The width W of the opening 12 is shorter than the diameter D of the channel 11. The internal thread 13 is formed on the inner surface of the channel 11.

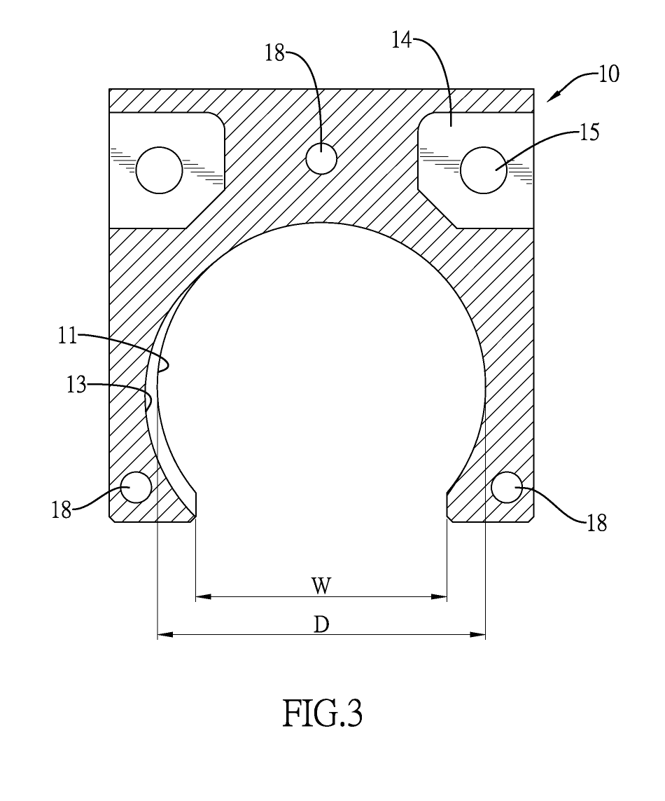

In addition, the body has two grooves 14, multiple through holes 15 and multiple notches 16. The grooves 14 are formed in the side surfaces of the body 10 respectively. The through holes 15 are formed in the top surface and the bottom surface of the body 10 respectively. The notches 16 are formed in the rear surface of the body 10 and are in communication with the grooves 14 respectively. With reference to FIGS. 1 and 3, the body 10 has multiple first connecting holes 17 and multiple second connecting holes 18. The first connecting holes 17 are formed in the top surface of the body 10. The second connecting holes 18 are formed in the bottom surface of the body 10.

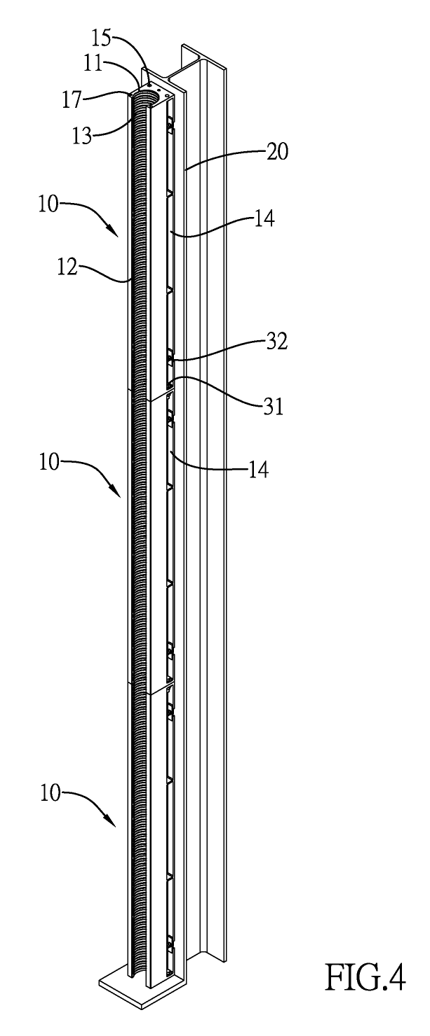

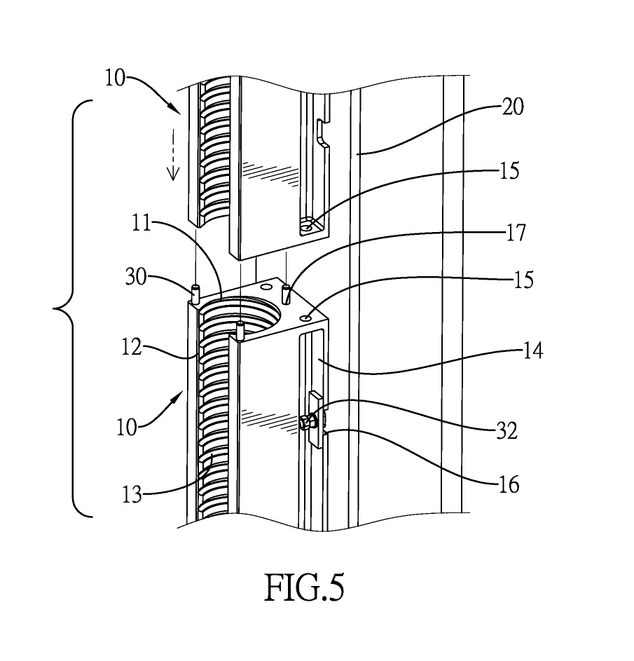

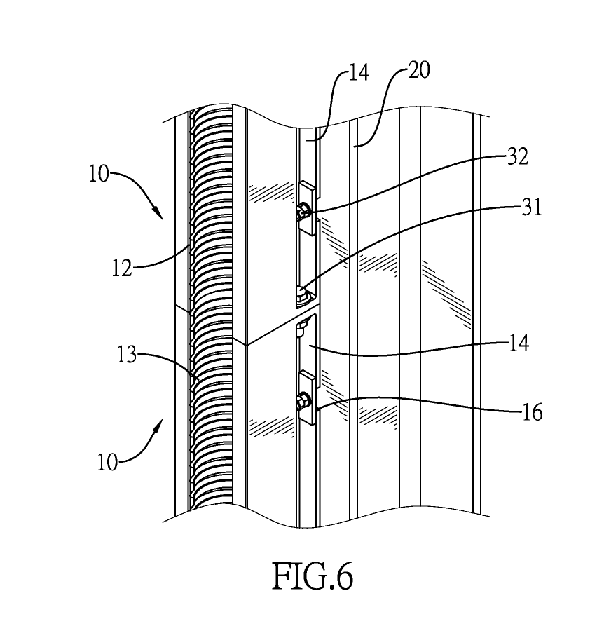

With reference to FIGS. 4 to 6, multiple column members are connected by multiple connectors 30 and multiple first bolts 31 to form a column assembly. The multiple column members include a first column member, a second column member, and so on. The connectors 30 are respectively inserted into the first connecting holes 17 in the top surface of the first column member, and the connectors 30 protrude out of the top surface of the first column member. The second column member is further mounted on the first column member. The connectors 30 mounted on the first column member are respectively inserted into the second connecting holes 18 of the second column member. The through holes 15 in the top surface of the first column member are respectively in communication with the through holes 15 in the bottom surface of the second column member for insertion of the first bolts 31.

With reference to FIGS. 4 to 6, the first column member and the second column member are combined with an external structure 20 such as a steel construction or ferroconcrete construction for increasing the strength of the column assembly. The rear surfaces of the first column member and the second column are connected to the external structure 20. Multiple second bolts 32 are respectively inserted through the notches 16 of the first column member and the second column member, and the multiple second bolts 32 are further screwed into the external structure 20 to fix the first column member and the second column member on the external structure 20.

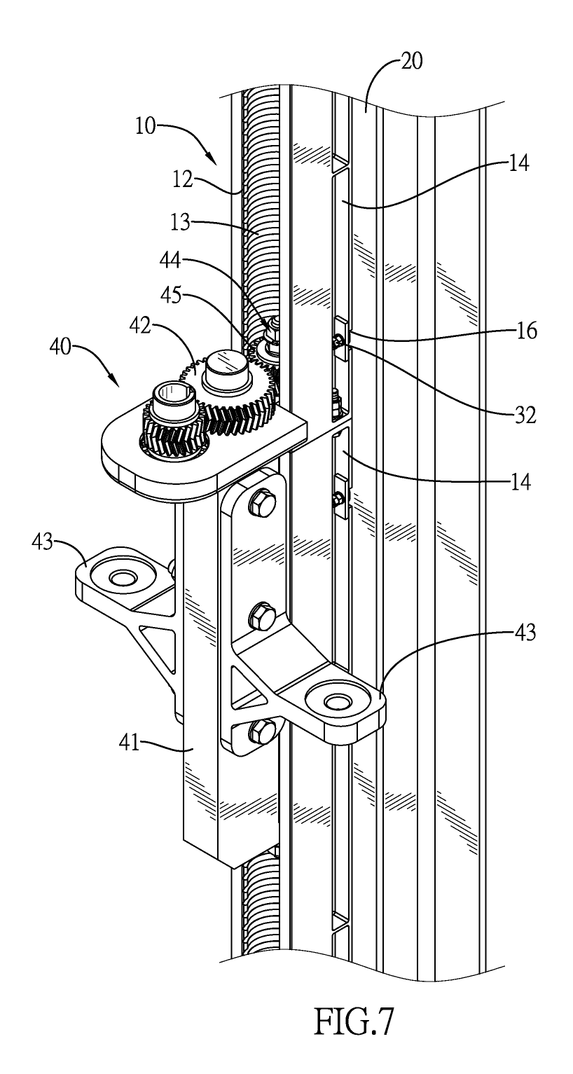

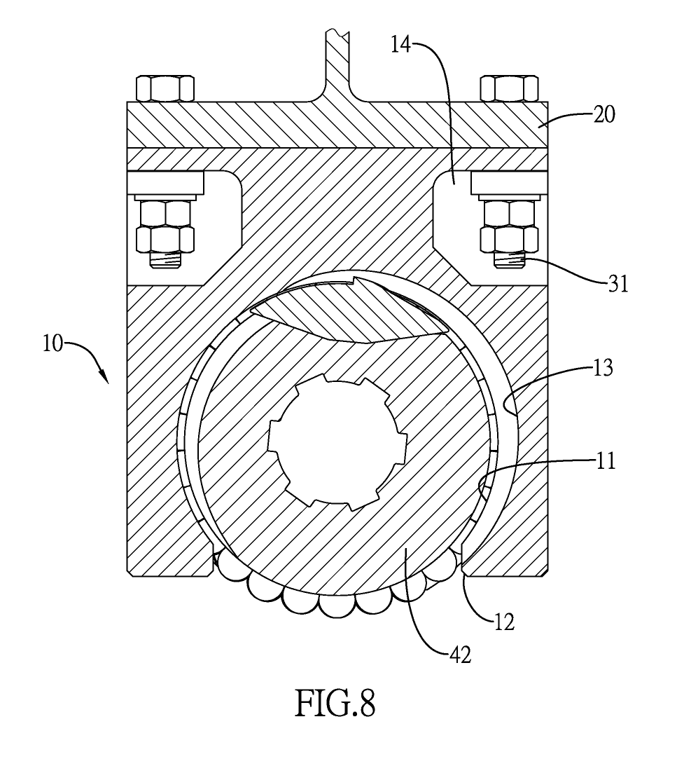

With reference to FIGS. 7 and 8, a driving device 40 is mounted on the column member. The driving device 40 has a seat 41, a motor, a driving gear 42, multiple loading frames 43 and a rotating member 44. The seat 41 is moveably mounted on the body 10 of the column member. The motor is mounted in the seat 41. The driving gear 42 is connected to a spindle of the motor and is located outside the seat 41. The loading frames 43 are mounted on the seat 41. The rotating member 44 has a driven gear 45 and is mounted in the channel 11 of the column member. The rotating member 44 is connected to the driving gear 42 via the driven gear 45 of the rotating member 44. The rotating member 44 is rotated by the motor to move upward and downward along the channel 11. The rotating member 44 engages with the internal thread 13 of the column member. The diameter of the rotating member 44 is equal to the diameter D of the channel 11. Therefore, the width W of the opening 12 is shorter than the diameter of the rotating member 44, so the rotating member 44 cannot come off the channel 11 of the column member via the opening 12 of the column member.

Accordingly, the width of the opening 12 is shorter than the diameter of the rotating member 44 to prevent the rotating member 44 from coming off the channel 11 via the opening 12. Thus, the rotating member 44 is located in the channel 11 firmly to prevent the driving device 40 from coming off the column member and reduce the horizontal component of force generated by the rotating member 44. The column member easily holds the rotating member 44 without any sliding elements, and the combination of the column member and the rotating member 44 is safe. In addition, multiple column members are easily connected by multiple connectors 30 and multiple first bolts 31, and the alignment precision between the multiple column members is improved.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A column member for an elevating device comprising:
a body having
a front surface;
a rear surface opposite to the front surface;
a top surface;
a bottom surface opposite to the top surface; and
two side surfaces opposite to each other;
a channel formed through the body and connected to the top surface and the bottom surface of the body, and having an inner surface;
an opening formed in the front surface of the body and communicating with the channel, and the width of the opening being shorter than the diameter of the channel; and
an internal thread formed on the inner surface of the channel.

2. The column member for an elevating device as claimed in claim 1, wherein
the body has
multiple grooves formed in the side surfaces of the body respectively; and
multiple through holes formed in the top surface and the bottom surface of the body respectively.

3. The column member for an elevating device as claimed in claim 2, wherein
the body has
multiple notches formed in the rear surface of the body and communicating with the grooves respectively.

4. The column member for an elevating device as claimed in claim 1, wherein
the body has multiple first connecting holes formed in the top surface of the body; and
multiple second connecting holes formed in the bottom surface of the body.

5. The column member for an elevating device as claimed in claim 2, wherein
the body has
multiple first connecting holes formed in the top surface of the body; and
multiple second connecting holes formed in the bottom surface of the body.

6. The column member for an elevating device as claimed in claim 3, wherein
the body has
multiple first connecting holes formed in the top surface of the body; and
multiple second connecting holes formed in the bottom surface of the body.
